(19) United States
(12) Patent Application Publication
(10) Pub. No.: US 2007/0066333 A1
(43) Pub. Date: Mar. 22, 2007

(54) Method of uplink preemption by later entry user equipment in trunking group with established group call

(75) Inventors: De Chen, Shenzhen (CN); Guang Liu, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/514,603

(22) Filed: Sep. 1, 2006

Related U.S. Application Data
(63) Continuation of application No. PCT/CN05/01408, filed on Sep. 5, 2005.

(30) Foreign Application Priority Data
Apr. 18, 2005 (CN) 200510064733.2

(51) Int. Cl. H04B 7/00; H04Q 7/20

(52) U.S. Cl. 455/518

(57) ABSTRACT

Disclosed is a method of uplink preemption by UEs later entering a trunking group with an established group call. With different priorities assigned for the UEs in the trunking group, after the uplink of the trunking group with an establish group call is occupied by a talker, the trunking group sends a message with the priority information of the talker to the listeners; the later entry UE determines according to the received message with the priority information of the talker whether its own configured priority is higher than that of the talker, if so, it determines that preemption for the uplink can be made; otherwise, it demodulates the group call channel downlink assigned for the trunking group when the group call was established, and listens to the voice. The later entry UE may then send an uplink access request and preempt the uplink when the UE has a higher priority.

### CROSS-REFERENCES TO RELATED APPLICATIONS

This is a continuation of International Application No. PCT/CN2005/001408, which was filed on Sep. 5, 2005, and which, in turn, claimed the benefit of Chinese Patent Application No. 200510064733.2, which was filed on Apr. 18, 2005, the entire disclosures of which are hereby incorporated herein by reference.

### BACKGROUND OF THE INVENTION

1. Field of the Invention

The present invention relates to the technique of uplink preemption for talking in a trunking radio communication system, and particularly, to a method of uplink preemption by later entry User Equipment (UE) in a trunking group in which a group call has already been established.

2. Background of the Disclosure

A trunking radio communication system hereinafter referred to as a trunking system, is an economic, flexible communication system for commanding and scheduling developed in recent years. It is widely applied in government organizations, energy and transportation enterprises, airports, harbors, fire-fighting police units, water conservancy facilities and military, for satisfying needs of internal communications and liaison of various corporations.

A primary service provided by the trunking system is a Voice Group Call Service (VGCS). The VGCS allows a UE to establish calls with a plurality of UEs who belong to a given service area and have the same group ID in the trunking group, where the service area includes at least one cells. The VGCS operates in half-duplex mode. During a call, any UE in the trunking group can be a talker, but only one UE is allowed to talk at one moment while other members of the trunking group are listeners.

FIG. 1 is a schematic diagram illustrating a procedure of a group call in the prior art. All the UEs in a trunking group belong to one base station. A pair of group call channels uplink and downlink is assigned to the UEs in the trunking group when the trunking group establishes a group call. One of the UEs in the trunking group talks as the current talker in a group transmit mode on the group call channel uplink, and other UEs in the trunking group listen to the talker as listeners in group receive mode on the group call channel downlink. The current talker may also talk in other uplinks assigned by the network side in the trunking group; the network side in the trunking group hereinafter is shortened as network side.

Description messages of a group call channel are transferred on the downlink, e.g. a Notification Channel (NCH). An uplink busy message is sent once after the network side has assigned an uplink for the talker, and an uplink free message is sent repeatedly by the network side while the uplink for talking is free, where the time interval between the repeated messages can be pre-defined by the network side.

After the voice group call is established, in some cases, e.g., the UE switches on thereafter, the UE enters the group call area of the trunking group thereafter, and the UE reenters initiatively after leaving the trunking group, the UE in said cases is referred to as a later entry UE.

After a later entry UE enters a trunking group with an established group call, there are two situations for the trunking group: First, no UE is talking, i.e., the uplink for talking is free; second, a UE is talking, i.e., the uplink for talking is busy. If no UE is talking, the network side will repeatedly send an uplink free message on the downlink so as to inform the later entry UE that the uplink is free and that he can send an uplink access request. If a UE is talking, no message will be sent except an uplink busy message, which is sent once after the network side assigned the uplink for the talker, and in this case, the later entry UE can not receive the uplink busy message because it enters the trunking group later. Instead, the UE will determine that the uplink is busy, if it does not receive the uplink free message within the pre-defined time interval. Then, the UE demodulates the group call channel downlink and listens to the voice sent on it.

Similarly, after the later entry UE sends the uplink access request, the network side responds to the uplink access request, and assigns the uplink to the UE for talking. And then the network side sends once an uplink busy message on the downlink. After receiving the uplink busy message, other UEs in the trunking group will demodulate the group call channel downlink for listening, and are not allowed to send uplink access requests until receiving an uplink free message from the network side.

The UEs in the trunking system may belong to different trunking groups, and may have different priorities in different groups. Within a trunking group, in order to render the following different service characteristics to different UEs, different priorities are configured for the different users, and are saved in the UEs:

1. The UEs with different priorities in a trunking group have different parameters configured during a random access, e.g. the repeated time intervals or times configured for transmission are different, etc. which lead to different success rates of access;

2. When the UEs with different priorities in a trunking group initiate the uplink access at the same time, the trunking system will determine to assign the uplink first for the UE with a higher priority, based on their priorities.

3. When a UE with a lower priority in the trunking group is talking on the uplink, the UEs with higher priorities can interrupt the talking of the UE with lower priority and talk by preempting the uplink.

For the implementation of the third characteristic above, the network side may as well send a message with a priority information of the talker while sending once the uplink busy message after assigning the talker the uplink, the message is referred to a information message thereafter. Such that other UEs in the trunking group can check, according to the priority information of the talker, whether its self-priority is higher than the talker's; if it is higher than the talker's, the uplink access request can be sent, and the network side will release the uplink occupied by the talker and assign the UE the uplink for talking; otherwise, the uplink access request can not be sent and the UE has to listen to the voice on the downlink.

After introducing the concept of priority to the trunking group, the method of uplink preemption by a later entry UE inherits that without priority, i.e., after the later entry UE enters the trunking group, if no uplink free message on the downlink is received, it will be determined that the current uplink has been occupied, the uplink access request can not be sent for preemption of the uplink. Then the later entry UE will demodulate the group call channel downlink and listen to the voice on the group call channel downlink. If receiving the uplink free message, the UE then determines that the current uplink is free and the uplink access request can be sent.

According to the prior art, after assigning the uplink for the UE who sends the uplink access request for talking, the network side will send once the information message to all the UEs currently in the trunking group on the downlink. Therefore, all the UEs currently in the trunking group can determine the priority of the current talker and whether its self-priority is higher than that of the current talker, and thereby determining whether to preempt the uplink. For a later entry UE, however, it is impossible, due to its later entry, to receive the information message which are sent once without receiving the uplink free message within the pre-defined time interval, and as a result, it is impossible for the later entry UE to know the priority of the current talker. Thus, even if the later entry UE has a higher priority, it can not send the uplink access request to the network side.

### SUMMARY OF THE INVENTION

According to the prior art, the present invention is to provide a method of uplink preemption by a UE who enters a trunking group with an established group call later, such that when the later entry UE in the trunking group with an established group call has a higher priority, this UE can send an uplink access request to the network side and preempt the uplink.

The method for the later entry User Equipment (UE) in a trunking group with an established group call to preempt uplink in accordance with this invention, assigns different priorities for UEs in the trunking group, including: after the uplink of the trunking group with an established group call is occupied by a UE as the talker, the trunking group sending a message with the priority information of the talker to the listeners; the later entry UE deciding according to the received message with the priority information of the talker whether its configured priority is higher than the talker's, if yes, determining that he can preempt the uplink; otherwise, demodulating the group call channel downlink assigned for the trunking group when the group call was established, and listening to the voice.

A trunking system is also provided for uplink preemption, including: a plurality of UEs with different priorities, including a later entry UE in a trunking group with an established group call, one of the UE occupies an uplink of the trunking group with the established group call as a talker, other UEs including the later entry UE are listeners on the downlink; the trunking group, which sends a information message with a priority information of the talker to the listener; the later entry UE, which determines according to the information message with the priority information of the talker whether its self-priority is higher than that of the talker, if it is higher than that of the talker, it determines the uplink can be preempted; otherwise, it listens on the downlink.

It can be seen from the above solution that, with the network side sending the information message to the later entry UE, it is possible that the later entry UE will not directly determine that he can not preempt the uplink without receiving the uplink free message, instead, the UE will further determines whether to preempts the uplink by comparing the priority of the talker with its own, and thereby determining whether to send to the network side an uplink access request. In order to make the later entry UE receive the information message, the network side may send the message repeatedly or on demand. In this way, the method provided by this invention makes the later entry UE to send an uplink access request to the network side and preempt the uplink when he has a higher priority.

### BRIEF DESCRIPTION OF THE DRAWINGS

FIG. 1 is a schematic diagram illustrating a group call procedure in the prior art;

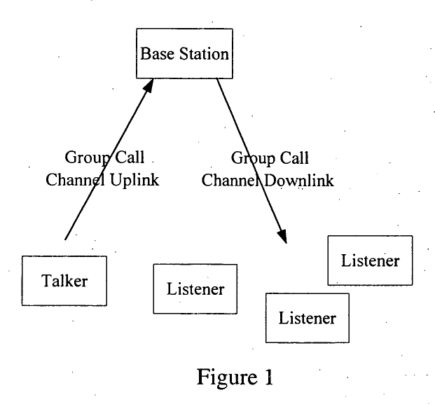

FIG. 2 is a flowchart illustrating the first embodiment of the method of uplink preemption by a later entry UE in a trunking group with an established group call in accordance with the present invention;

FIG. 3 is a flowchart illustrating the second embodiment of the method of uplink preemption by a later entry UE in a trunking group with an established group call in accordance with the present invention.

### DETAILED DESCRIPTION OF THE PREFERRED EMBODIMENTS

A description in detail is given hereinafter with reference to the specific embodiments and the accompanying drawings.

A priority of the current talker is informed in time to a later entry UE by sending repeatedly an information message with priority information of the talker. The later entry UE is a UE enters a trunking group with an established group call later. So that the later entry UE can make sure the priority of the current talker, and determines whether its self-priority is higher than that of the current talker, and accordingly, determines whether to preempt the uplink.

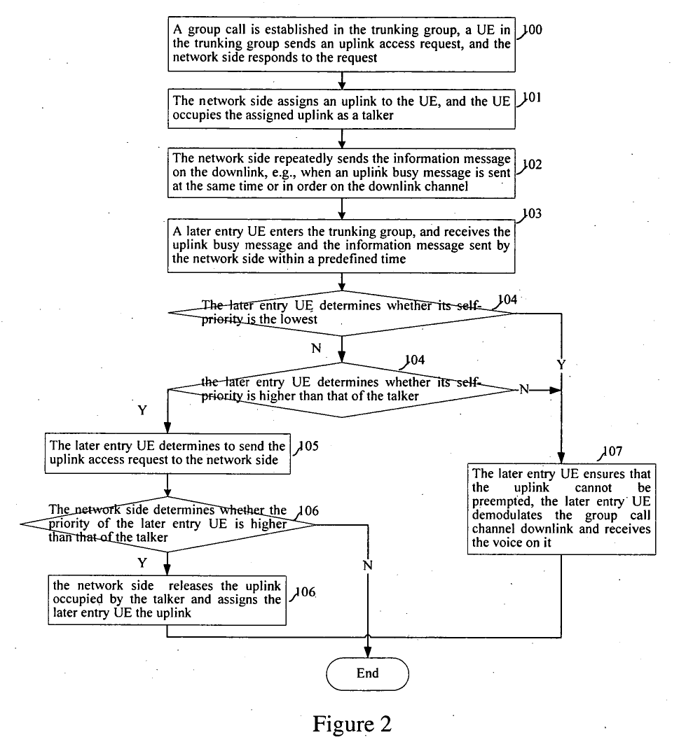

As shown in FIG. 2, which is a flowchart of the first embodiment of the method of uplink preemption by later entry UE in accordance with the present invention, the detailed steps of the first embodiment include the following.

Step 100: A group call is established in the trunking group, a UE in the trunking group sends an uplink access request, and the network side responds to the request.

Step 101: The network side assigns an uplink to the UE, and the UE occupies the assigned uplink as a talker.

Step 102: The network side repeatedly sends the information message on the downlink, e.g., when an uplink busy message is sent at the same time or in order on a NCH.

The time interval of the repeated transmission can be pre-defined by the network side.

The uplink busy message and the information message can be one downlink message, or two downlink messages sent at the same time.

In accordance with the present embodiment, the information message can be repeatedly send only. The later entry UE can determine that the current uplink is occupied so long as the UE receives the information message.

Step 103: A later entry UE enters the trunking group, and receives the uplink busy message and the information message sent by the network side within a pre-defined time interval.

The time interval pre-defined by the later entry UE is usually equal to or longer than the time interval of the repeated transmission of the uplink busy message and the information message.

Step 104: The later entry UE determines whether its self-priority is the lowest, if it is the lowest, executes the step 107; otherwise, the later entry UE determines whether its self-priority is higher than that of the talker according to the priority information of the talker, if it is higher than that of the talker, executes the step 105, otherwise executes the step 107.

Step 105: The later entry UE determines to preempt the uplink, and sends the uplink access request to the network side.

Step 106: The network side determines whether the priority of the later entry UE is higher than that of the talker, if it is higher than that of the talker, the network side releases the uplink occupied by the talker and assigns the later entry UE the uplink; the later entry UE occupies the assigned uplink to talk; otherwise, the network side does not response to the uplink access request or sends an access failure message to the later entry UE.

For the purpose of implementing the determining procedure of the network side in this step, the later entry UE carries its self-priority when sending the uplink access request.

Step 107: The later entry UE ensures that the uplink cannot be preempted, the later entry UE demodulates the group call channel downlink and receives the voice on it.

When the later entry UE enters the trunking group with an establish group call and the uplink of this trunking group is free, i.e., the later entry UE receives the uplink free message sent repeatedly by the network side, the handling procedure is the same as the procedure in the prior art.

In accordance with this embodiment, the information message can not be sent repeatedly but sent on demand, i.e., when the network side detects a later entry UE, sending a downlink message once to the later entry UE, and this downlink message carries the priority information of the talker. The detecting procedure include: when the later entry UE enters the trunking group, sending an uplink message indicating the UE has entered the trunking group to the trunking group.

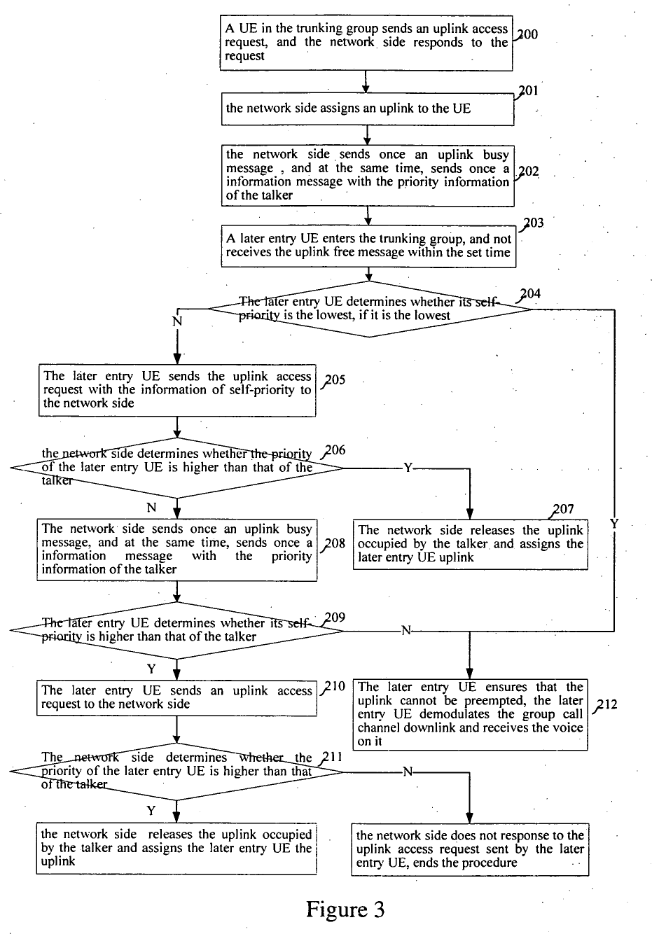

As shown in FIG. 3, which is the flowchart of the second embodiment of the present invention, the steps of the embodiment include the following.

Step 200: The trunking group has established a group call, a UE in the trunking group sends an uplink access request, and the network side responds to the request.

Step 201: the network side assigns an uplink to the UE, and the UE occupies the assigned uplink as a talker.

Step 202: the network side sends once on the downlink, e.g., NCH, an uplink busy message, and at the same time, sends once a information message with the priority information of the talker.

All the UEs currently in the trunking group can compare their self-priorities with that of the talker, and determine accordingly whether the uplink access request is sent.

Step 203: A later entry UE enters the trunking group, and not receives the uplink free message within the set time.

The time pre-defined by the later entry UE is usually equal to or longer than the time interval of repeated transmission of the uplink free messages.

Step 204: The later entry UE determines whether its self-priority is the lowest, if it is the lowest, executing step 212; otherwise, that of the talker executing step 205.

Step 205: The later entry UE sends the uplink access request with the information of self-priority to the network side.

Step 206: After receiving the uplink access request, the network side determines according to the priority information of the later entry UE whether the priority of the later entry UE is higher than that of the talker, if it is higher than that of the talker, executing step 207; otherwise executing step 208.

Step 207: The network side releases the uplink occupied by the talker and assigns the later entry UE uplink; the later entry UE occupies the assigned uplink to talk.

Step 208: The network side sends once on the downlink, e.g., NCH, an uplink busy message, and at the same time, sends once a information message with the priority information of the talker.

The uplink busy message and the information message can be one downlink message, or two downlink messages sent at the same time or in order.

Step 209: The later entry UE determines according to the priority information of the talker whether its self-priority is higher than that of the talker, if it is higher than that of the talker, executing step 210, otherwise, executing step 212.

Step 210: The later entry UE ensures that the uplink can be preempt, and sends an uplink access request to the network side.

Step 211: The network side determines whether the priority of the later entry UE is higher than that of the talker, if it is higher than that of the talker, the network side releases the uplink occupied by the talker and assigns the later entry UE the uplink; the later entry UE occupies the assigned uplink to talk; otherwise, the network side does not response to the uplink access request sent by the later entry UE or sends an access failure message to the later entry UE.

For the purpose of implementing the determining procedure of the network side, the later entry UE carries its self-priority when sending the uplink access request.

Step 212: The later entry UE ensures that the uplink cannot be preempted, the later entry UE demodulates the group call channel downlink and receives the voice on it.

In accordance with this embodiment, the later entry UE in the trunking group with the established group call can send the uplink message to inform the network side that there is a later entry UE. In this case, the network side can directly perform steps 208-212.

When the later entry UE enters the trunking group with the established group call and the uplink of this trunking group is free, i.e., the later entry UE receives the uplink free message sent repeatedly by the network side, the handling procedure is the same as the procedure in the prior art.

By the solution as shown in FIG. 2 or 3, the later entry UE in the trunking group with the established group call, not receiving the uplink free message, will not determine directly that the uplink cannot be preempted. However, the UE will further obtain the priority information of the talker, determines according to the priority information whether the priority of the talker is higher than its own configured priority, and then determines whether the uplink can be preempted, accordingly determines whether to send the uplink access request to the network side.

The foregoing description is only the preferred embodiments of this invention and is not to be used for limiting the protection scope of this invention. Any modification, equivalent substitution, improvement, etc., within the spirit and principle of this invention should be covered by the protection scope of this invention.

1. A method of uplink preemption by a later entry User Equipment (UE) in a trunking group with an established group call, wherein the trunking group comprises a plurality of UEs with different priorities, the method comprising:
one of the UEs occupies an uplink of the trunking group as a talker, other UE is a listener;
the trunking group sending an information message with a priority information of the talker to the listener;
an later entry UE which enter the trunking group later determining according to the information message whether its self-priority is higher than that of the talker, if it is higher than that of the talker, determining the uplink can be preempted;
otherwise, listening on the downlink.

2. The method according to claim 1, wherein, the information message is sent repeatedly by the trunking group at a pre-defined time interval on the downlink.

3. The method according to claim 2, further comprising, the trunking group sends repeatedly an uplink busy message indicating the uplink is busy at the pre-defined time interval.

4. The method according to claim 3, wherein, the uplink busy message and the information message are sent in one downlink message.

5. The method according to claim 1, wherein, if the later entry UE does not receive the uplink free message, it sends an uplink message to the trunking group;
the trunking group, which receives the uplink message, sends the information message to the later entry UE on the downlink.

6. The method according to claim 5, wherein, the uplink message carries the priority information configured for the later entry UE.

7. The method according to claim 6, before the trunking group sends the information message to the later entry UE, further comprising:
determining according to the received priority information of the later entry UE whether the priority of this later entry UE is higher than that of the talker,
if it is higher than that of the talker, releasing the uplink occupied by the talker and assigning the uplink for the later entry UE,
otherwise, sending to the later entry UE the information message.

8. The method according to claim 5, before the later entry UE sends the uplink message to the trunking group, further comprising:
determining whether its self-priority is the lowest in the trunking group;
if it is lowest, listening on the downlink;
otherwise, sending the uplink message to the trunking group.

9. The method according to claim 1, after the later entry UE determines the uplink can be preempted, further comprising:
the later entry UE sending an uplink access request to the trunking group;
the trunking group releasing the uplink occupied by the talker after receiving the uplink access request, and assigning the uplink to the later entry UE.

10. The method according to claim 9, wherein, the uplink access request carries the priority information configured for the later entry UE.

11. The method according to claim 10, before the trunking group releases the uplink occupied by the talker, further comprising:
the trunking group determining according to the received priority information of the later entry UE carried by the uplink access request whether the priority of the later entry UE is higher than that of the talker,
if it is higher than that of the talker, the trunking group releasing the uplink occupied by the talker;
otherwise, the trunking group not respond to the uplink access request or sending an access failure message to the later entry UE.

12. The method according to claim 3, wherein the downlink is a Notification Channel (NCH).

13. The method according to claim 5, wherein the downlink is the NCH.

14. A trunking system for uplink preemption, comprising:
a plurality of User Equipments (UEs) with different priorities, including a later entry UE;
a trunking group with an established group call;
the later entry UE enter the trunking group later;
one of the UEs occupies an uplink of the trunking group as a talker, other UEs are listeners on the downlink;
the trunking group sends an information message with a priority information of the talker to the listener;
the later entry UE determines according to the information message with the priority information of the talker whether its self-priority is higher than that of the talker, if it is higher than that of the talker, it determines the uplink can be preempted; otherwise, it listens on the downlink.

15. The system according to claim 14, the trunking group sends repeatedly an information message on the downlink at a pre-defined time interval.

16. The system according to claim 14, if the later entry UE does not receive an uplink free message sent repeatedly by the trunking group within the pre-defined time, it sends an uplink message to the trunking group;
the trunking group, which receives the uplink message, sends the information message to the later entry UE on the downlink.
